(19) United States
(12) Patent Application Publication
(10) Pub. No.: US 2026/0195243 A1
(43) Pub. Date: Jul. 9, 2026

(54) AUTOMATICALLY ATTEMPTING TO RETRIEVE AND RUN CURRENT HEALTH CHECK SOFTWARE BEFORE UPGRADING TO A NEW SOFTWARE VERSION

(71) Applicant: Dell Products L.P., Round Rock, TX (US)

(72) Inventors: Vamsi K. Vankamamidi, Hopkinton, MA (US); Samuel L. Mullis, II, Raleigh, NC (US); Geng Han, Beijing (CN)

(21) Appl. No.: 19/013,178

(22) Filed: Jan. 8, 2025

(51) Int. Cl. G06F 11/3668; G06F 8/65

(52) U.S. Cl. CPC G06F 11/3672; G06F 8/65

(57) ABSTRACT

Techniques are directed to upgrading software within computerized equipment. Such techniques involve receiving an upgrade package defining an upgrade routine constructed and arranged to automatically attempt to retrieve and run current health check software from a software repository before upgrading an earlier software version to a new software version within the computerized equipment. The software repository is external to the computerized equipment. Such techniques further involve receiving an upgrade command to perform the upgrade routine defined by the upgrade package. Such techniques further involve, in response to the upgrade command and in accordance with the upgrade routine, automatically attempting to retrieve and run the current health check software from the software repository before upgrading the earlier software version to the new software version within the computerized equipment.

### BACKGROUND

Conventional computerized systems run software to perform useful work. Examples of such systems include data storage arrays which write data into and read data from arrangements of storage drives in response to input/output (I/O) requests from host computers.

From time to time, such conventional computerized systems may upgrade various software components (e.g., portions of operating systems, management software, performance tools, utilities, combinations thereof, etc.). To carry out such upgrades, the conventional computerized systems download upgrade modules which include pre-upgrade health check (PUHC) software and new software releases. The conventional computerized systems then run the PUHC software to validate the statuses of various system conditions. Without such validation, the systems may not be ready for the upgrades and could unexpectedly fail, perhaps leaving the systems in failed states. After the PUHC software determines that the systems are ready and that it is safe to perform the upgrades, system administrators may then direct the systems to upgrade to the new software releases.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a block diagram of a computerized environment in which computerized equipment automatically attempts to retrieve and run current health check software before upgrading to a new software version in accordance with certain embodiments.

FIG. 2 is a block diagram of electronic equipment which is suitable for at least a portion of the computerized equipment in accordance with certain embodiments.

FIG. 3 is a block diagram of an example upgrade package in accordance with certain embodiments.

FIG. 4 is a flowchart of a procedure which is performed by a software source in accordance with certain embodiments.

FIG. 5 is a flowchart of a procedure which is performed by a computerized platform in accordance with certain embodiments.

FIG. 6 is a block diagram an example upgrade situation in accordance with certain embodiments.

### DETAILED DESCRIPTION

It should be understood that there are deficiencies to simply downloading upgrade modules which include pre-upgrade health check (PUHC) software and new software releases, and running the PUHC software beforehand. Along these lines, after running the PUHC software to validate the statuses of various system conditions, system administrators may delay performing the upgrades. For example, system administrators may schedule the upgrades to occur during upcoming maintenance windows (e.g., late at night, on weekends, etc.) when the systems are less busy. During such delays, system conditions may change thus placing the systems at higher risk of failure when the upgrades are eventually performed.

Additionally, it should be appreciated that after software providers make upgrade modules available for downloading, the software providers may discover problematic issues with new software releases. Along these lines, the software providers may learn from recent upgrade sites that the new software releases cause problems under certain system conditions, configurations, etc. (e.g., by inadvertently introducing software bugs or creating instabilities in certain conditions, configurations, etc.).

However, other sites which intend to upgrade and which have the same system conditions, configurations, etc. may have already downloaded the upgrade modules. Moreover, these other sites may have already run the PUHC software and scheduled the upgrades to the new software releases during upcoming maintenance windows. Unfortunately, even though the upgrades have not yet been performed at these other sites but it is already known that upgrading under such conditions, configurations, etc. may be problematic, there may be no opportunities for the other sites to take corrective measures and prevent the upgrades at these other sites. What is needed, therefore, is a way to dynamically ascertain whether to perform a software upgrade just before performing the upgrade.

The above need is addressed at least in part by an improved technique of upgrading software within computerized equipment. In accordance with this technique, an upgrade package defines an upgrade routine constructed and arranged to automatically attempt to retrieve and run current health check software from a software repository (or upgrade routine source) before upgrading an earlier software version to a new software version within the computerized equipment. The current health check software (which may have been made available after the upgrade package was released in order to check for recently discovered problematic system conditions, configurations, etc.) may then block/prevent the upgrade to the new software version thereby avoiding creation of problematic situations.

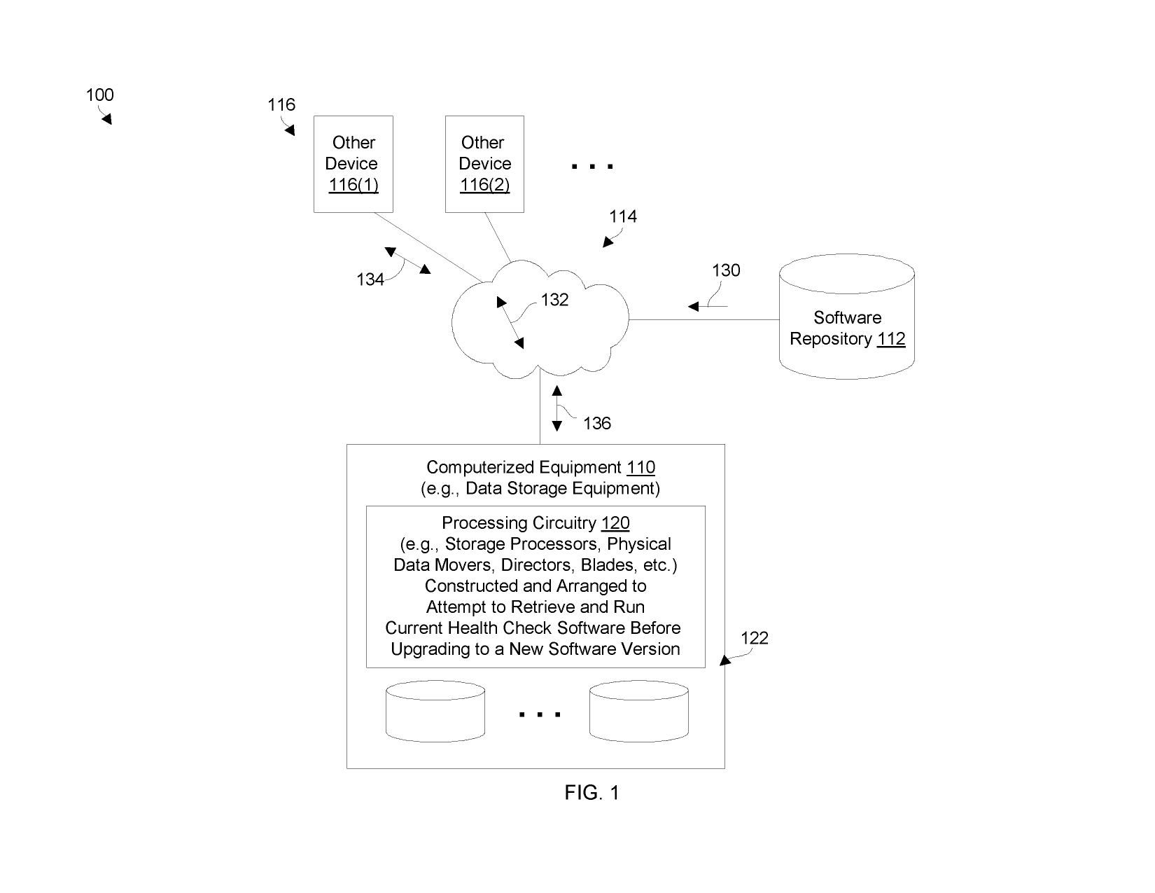

FIG. 1 shows a computerized environment 100 in which computerized equipment automatically attempts to retrieve and run current health check software before upgrading to a new software version in accordance with certain embodiments. The computerized environment 100 includes computerized equipment 110, a software repository 112, a communications medium 114, and perhaps other devices 116(1), 116(2), … (collectively, other devices 116).

The computerized equipment 110 is constructed and arranged to perform useful work. The computerized equipment 110 includes processing circuitry 120, and storage devices 122 coupled with the processing circuitry 120. Along these lines, the storage devices 122 provide non-volatile storage for software that the processing circuitry 120 uses to perform computerized operations. As will be explained in further detail shortly, the software may be updated from time to time via an improved upgrade technique.

The software repository 112 is constructed and arranged to provide software upgrade packages 130 to the computerized equipment 110 to enable software upgrades. Such software upgrade packages 130 may be provided from time to time to correct bugs in earlier software versions, to provide software enhancements, combinations thereof, and so on.

Example types of software upgrade packages 130 include those for upgrading to new versions of operating systems, management software, performance software, utilities, combinations thereof, and so on. In some arrangements, the software repository 112 may be a website or a storefront which enables computerized equipment 110 at different installation locations to easily retrieve the upgrade packages 130 as downloads and then install new software versions from the downloaded upgrade packages 130.

The communications medium 114 is constructed and arranged to connect the various components of the computerized environment 100 together to enable these components to exchange electronic signals 132 (e.g., see the double arrow 132). At least a portion of the communications medium 114 is illustrated as a cloud to indicate that the communications medium 114 is capable of having a variety of different topologies including backbone, hub-and-spoke, loop, irregular, combinations thereof, and so on. Along these lines, the communications medium 114 may include copper-based data communications devices and cabling, fiber optic devices and cabling, wireless devices, combinations thereof, etc. Furthermore, the communications medium 114 is capable of supporting LAN-based communications, SAN-based communications, cellular communications, combinations thereof, etc.

The other devices 116 are constructed and arranged to perform useful work and to communicate with the computerized equipment 110 through the communications medium 114. Along these lines, the other devices 116 may be client devices that request services from the computerized equipment 110, vice versa, or both.

By way of example, the computerized environment 100 is a data storage environment, the computerized equipment 110 is storage equipment, and the other devices 116 are host computers that provide I/O requests 134 to the storage equipment to load and store data 136. Along these lines, the processing circuitry 120 of the computerized equipment 110 may include storage processors which operate in a tightly coupled manner (e.g., together as a single appliance) and/or in a less tightly coupled manner (e.g., as a cluster of appliances).

In some situations, the processing circuitry 120 may operate as a file server, a web server, an email server, an enterprise server, a database server, a transaction server, combinations thereof, etc. which processes the I/O requests 134 to write and read data 136. In this context, the devices 116 may provide a variety of different I/O requests 134 (e.g., block and/or file based write commands, block and/or file based read commands, combinations thereof, etc.) that direct the computerized equipment 110 to store data 136 within and/or retrieve data 136 from the storage devices 122 (e.g., primary storage or main memory, secondary storage, tiered storage, combinations thereof, etc.).

In this data storage environment example, multiple storage processors of the processing circuitry 120 may provide fault tolerance and the ability to load balance. Along these lines, the computerized equipment 110 offers high availability (e.g., the processing circuitry 120 continues to provide access to the data 136 even if there is a storage processor failure).

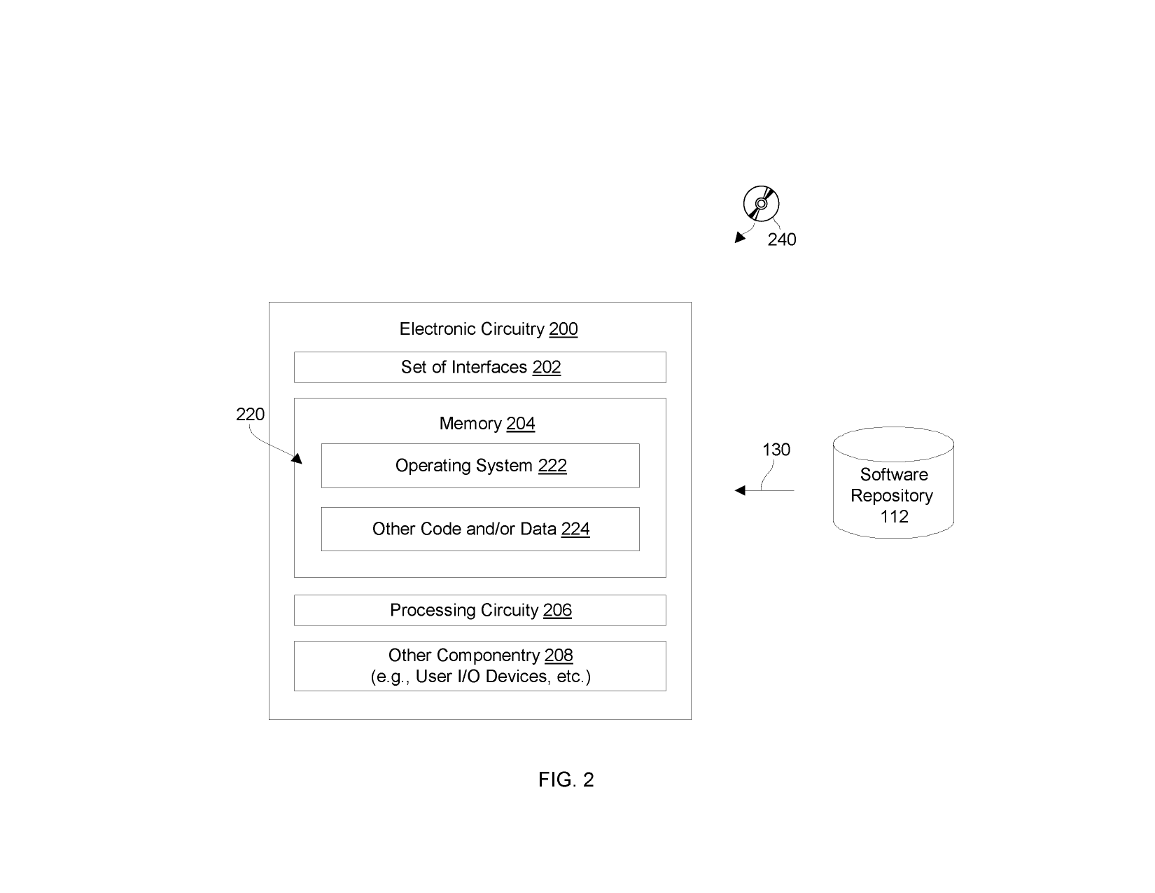

As will be explained in further detail below, the improved upgrade technique enables the computerized equipment 110 to retrieve the latest (or most current) health check software from the software repository 112 before upgrading an earlier software version to a new software version using a downloaded upgrade package 130. Along these lines, the provider of the upgrade package 130 may have posted (or made available) the latest health check software on the software repository 112 even after the computerized equipment 110 downloaded the upgrade package 130. Nevertheless, the computerized equipment 110 may then retrieve and run the latest health check software to determine whether it is safe to immediately proceed to the upgrade. Further details will now be provided with reference to FIG. 2.

FIG. 2 shows electronic circuitry 200 which is capable of automatically attempting to retrieve and run current health check software before upgrading to a new software version in accordance with certain embodiments. Such electronic circuitry 200 is suitable for at least a portion of the computerized equipment 110 of the computerized environment 100 (also see the processing circuitry 120 in FIG. 1). As shown in FIG. 2, the electronic circuitry 200 includes a set of interfaces 202, memory 204, a set of processors 206, and other componentry (or circuitry) 208.

The set of interfaces 202 is constructed and arranged to connect the electronic circuitry 200 to the communications medium 114 (FIG. 1) to enable communications with other devices of the environment 100. Such communications may be IP-based, SAN-based, cellular-based, cable-based, fiber-optic based, wireless, cloud-based, combinations thereof, and so on. Accordingly, the set of interfaces 202 may include one or more host interfaces (e.g., a computer network interface, a fibre-channel interface, etc.), one or more storage device interfaces (e.g., a host adapter or HBA, etc.), and other interfaces. As a result, the set of interfaces 202 enables the electronic circuitry 200 to robustly and reliably communicate with various apparatus.

The memory 204 is intended to represent both volatile storage (e.g., DRAM, SRAM, etc.) and non-volatile storage (e.g., solid state memory, magnetic memory, etc.). The memory 204 stores a variety of software constructs 220 including an operating system 222, and other code and data 224. The operating system 222 refers to particular control code such as a kernel to manage computerized resources (e.g., processor cycles, memory space, etc.), the I/O stack (e.g., drivers), and so on. The other code and data 224 refers to particular instructions and/or other software constructs for, among other things, performing useful work (e.g., storage operations, management routines, optimizations, combinations thereof, etc.). In some situations, all or parts of the other code and data 224 are tightly integrated with the operating system 222 (e.g., run in privileged mode, share operating system components, etc.). In other situations, all or parts of the other code and data 224 are less tightly integrated with the operating system 222 (e.g., operate in user space, run on top of a hypervisor, etc.).

The set of processors 206 is constructed and arranged to operate in accordance with the various software constructs 220 stored in the memory 204. Along these lines, the set of processors 206 may execute the other code and data 224 to form specialized circuitry that robustly and reliably performs useful work. Such a set of processors 206 may be implemented in a variety of ways including via processing cores and/or chip sets running specialized software, application specific ICs (ASICs), field programmable gate arrays (FPGAs) and associated programs, discrete components, analog circuits, other hardware circuitry, combinations thereof, and so on. In the context of one or more processors executing software, a computer program product 240 is capable of delivering all or portions of the software constructs 220 to the electronic circuitry 200. In particular, the computer program product 240 has a non-transitory (or non-volatile) computer readable medium which stores a set of instructions that controls one or more operations of the electronic circuitry 200. Examples of suitable computer readable storage media include tangible articles of manufacture and apparatus which store instructions in a non-volatile manner such as DVD, CD-ROM, flash memory, disk memory, tape memory, and the like.

The other componentry 208 refers to other hardware of the electronic circuitry 200. Along these lines, the electronic circuitry 200 may further include specialized equipment such as a user interface, power supplies, fans, specialized equipment, etc.

It was mentioned above that the electronic circuitry 200 is suitable for forming at least a portion of the computerized equipment 110. In the context of data storage, the electronic circuitry 200 may be part of a storage appliance, or a storage processor, and so on.

However, it should be also understood that such electronic circuitry 200 may be suitable for forming at least a portion of one or more of the other devices 116. That is, one or more of the other devices 116 may include similar circuitry and may therefore be capable of automatically attempting to retrieve and run current health check software before upgrading to a new software version.

During operation, the electronic circuitry 200 retrieves an update package 130, which defines an upgrade routine, from the software repository 112 to upgrade an earlier version of software to a new version of software. Then, by running in accordance with the upgrade routine, the electronic circuitry 200 automatically attempts to retrieve and run current health check software from the software repository 112 before upgrading the earlier software version to the new software version.

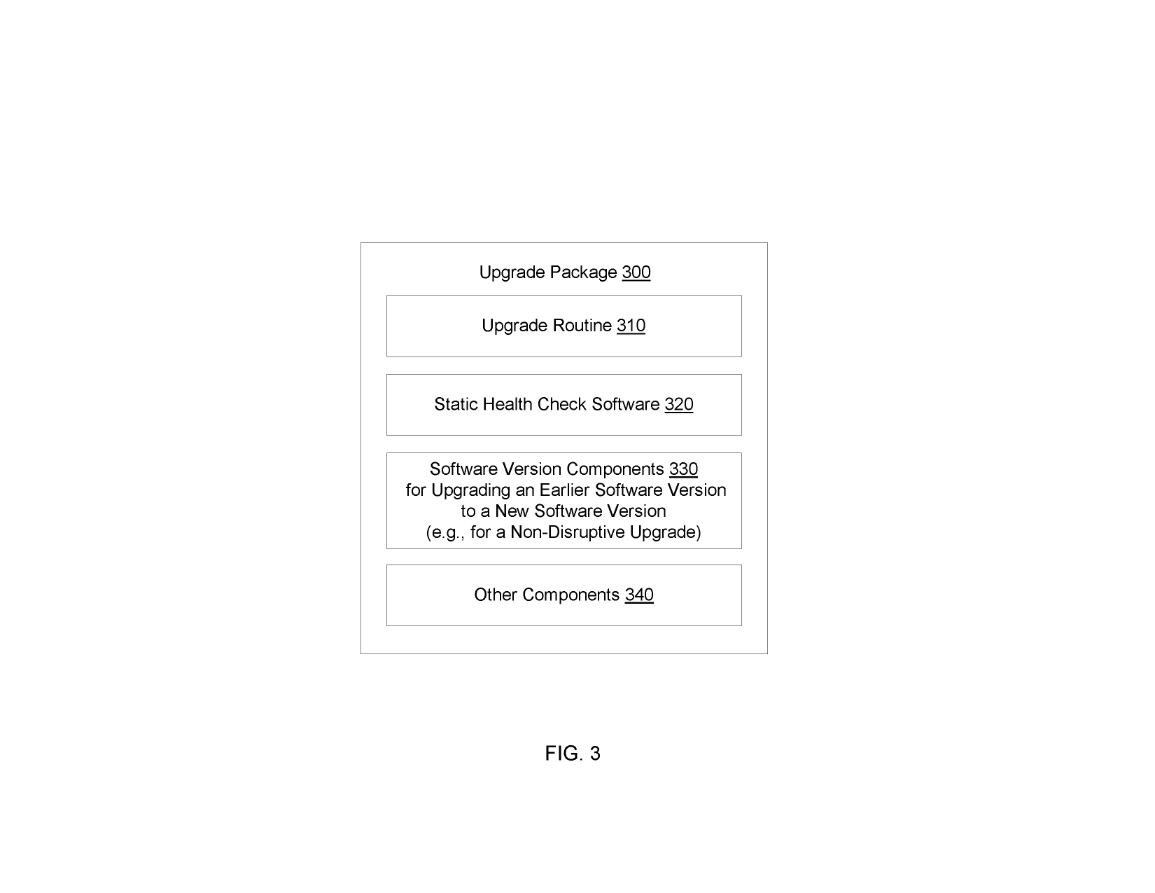

FIG. 3 shows an example upgrade package 300 in accordance with certain embodiments. The upgrade package 300, which may be downloaded by a computerized platform (e.g., see the computerized equipment 110 in FIG. 1) includes an upgrade routine 310, static health check software 320, software version components 330, and other components 340.

The upgrade routine 310 is constructed and arranged to direct the computerized platform to attempt to retrieve and run current health check software from the software repository 112 (FIG. 1) before upgrading an earlier software version to a new software version. Along these lines, the upgrade routine 310 may specify a location in the software repository 112 which stores the current health check software (e.g., an address, a link, a path to a set of files, etc.). Then, the computerized platform running in accordance with the upgrade routine 310 retrieves the current health check software from the specified location.

The static health check software 320 is traditional health check software that normally accompanies a new software release. Along these lines, the static health check software 320 may be pre-upgrade health check (PUHC) software to validate the status of the computerized platform to be upgraded (also see FIG. 1). Without such validation, the computerized platform may not be ready for the upgrade and could unexpectedly fail, perhaps leaving the computerized platform in a failed state. Accordingly, the computerized platform should only perform the upgrade to the new software version after passing the PUHC.

As will be explained in further detail shortly, an improved technique is able to rely on the upgrade routine 310 to evaluate the computerized platform for certain conditions, configurations, etc. that were identified as posing potential issues. Accordingly, the computerized platform is safeguarded against known and addressed situations that arise after the static health check software 320 is created and provided.

The software version components 330 are the software constructs that are used to upgrade an earlier software version to a new software version. In some arrangements, the software version components 330 enable the computerized platform to perform a non-disruptive upgrade (NDU). Along these lines, the computerized platform may include multiple processing elements (e.g., multiple appliances, multiple storage processors, combinations thereof, etc.) and the upgrade may involve upgrading one processing element at a time while one or more other processing elements continue to perform useful work (e.g., continue to process I/O requests). As a result, the computerized platform achieves the upgrade with continuous operation (i.e., without disruption).

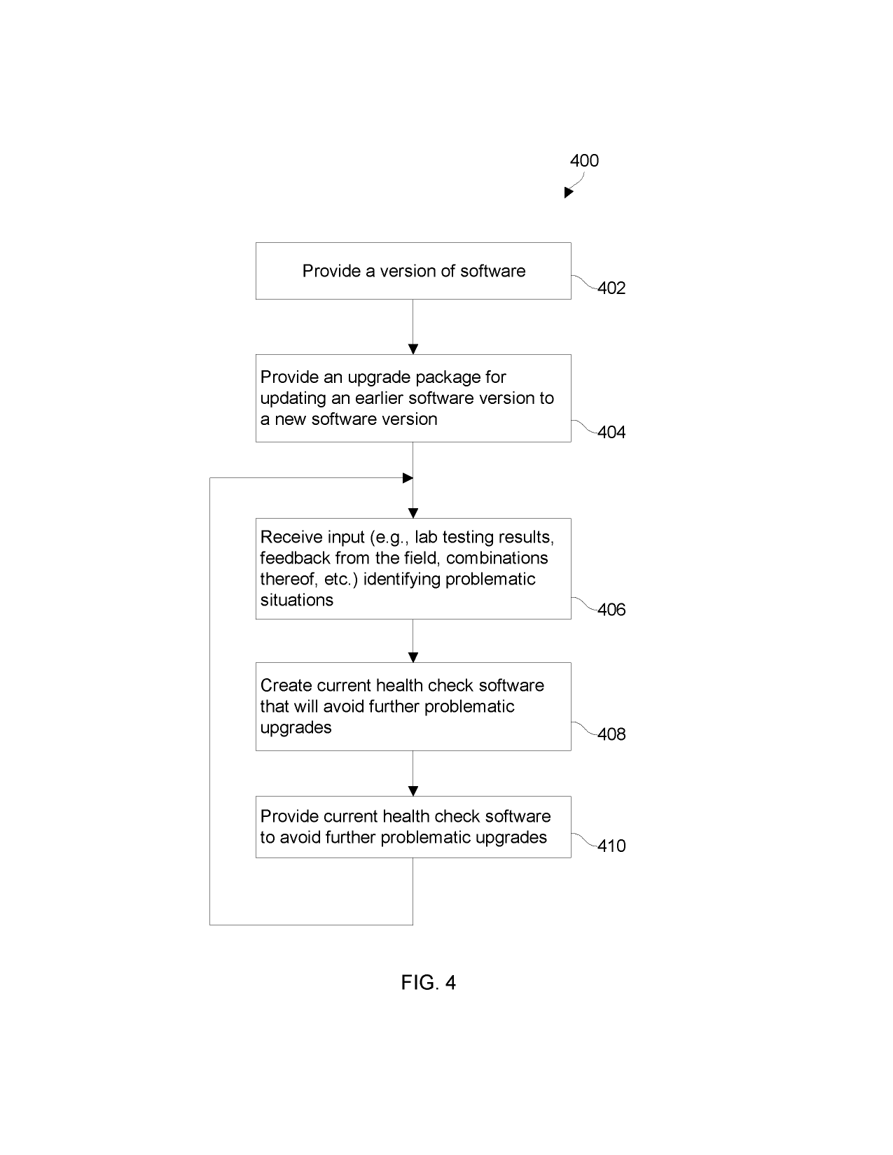

The other components 340 refer to other parts of the upgrade package 300. For example, the upgrade package 300 may include instructions/guidelines, tools, utilities, a de-installation application, combinations thereof, and so on. Further details will now be provided with reference to FIG. 4.

FIG. 4 is a flowchart of a procedure 400 which is performed by a software source in accordance with certain embodiments (e.g., see the software repository 112 in FIG. 1). Such a source may be operated by a software developer that provides software and updates to versions of the software from time to time.

At 402, the source provides a version of software. For example, the source may provide an initial software version for first time installation on computer platforms. Along these lines, the software may be an operating system, an application that is tightly integrated with an operating system (e.g., a low-level optimized data storage application), a high level application (e.g., software that runs in user-level space), software that runs within containers and/or in embedded systems, combinations thereof, etc. In some arrangements, the software may include health check software constructed and arranged to examine a computerized platform for compatibility, suitability, etc. prior to installing the software to avoid a problematic install of the software version. As a result, computerized platforms are then able to download and install the version of software.

At 404, after the version of software is provided, the source provides an upgrade package for updating an earlier software version (e.g., the initial software version) to a new software version. Along these lines, the source may have configured the upgrade package to fix bugs in the earlier software version, add new features/enhancements, combinations thereof, etc. FIG. 3 shows an example upgrade package 130 which is suitable for the upgrade package provided at 404. As explained earlier, such an upgrade package may include static pre-update health check software as well as an upgrade routine constructed and arranged to attempt to retrieve and run current health check software before upgrading the earlier software version to the new software version.

At 406, the source receives input identifying problematic situations. Here, computerized platforms that upgraded from the earlier software version to the new software version may have provided feedback. Such feedback from the field may include reports that certain computerized platforms have experienced problems since the upgrade (e.g., bugs, anomalies, etc.). In parallel or in response to the feedback, the source may perform lab testing, analysis, research, etc. to conclude that other computerized platforms having certain situations (e.g., particular conditions, configurations, etc.) should avoid installing the new software version at least until after a set of remedial adjustments are made.

At 408, the source creates current health check software that will avoid creating problematic situations on other computerized platforms having similar conditions, configurations, etc. Along these lines, the current health check software may be constructed and arranged to test for the certain situations that encounter the problems and then block the upgrade to give time for the source to come out with a solution. Alternatively, the current health check software may be constructed and arranged to make adjustments to the computerized platforms (perhaps by first prompting the operator for permission) to prevent the new software version causing the problems and then allow the upgrade to proceed.

At 410, the source provides the current health check software to avoid further problematic upgrades. Accordingly, the other computerized platforms that use the upgrade package (made available at 404) will run the upgrade routine which is constructed and arranged to retrieve and run current health check software before upgrading the earlier software version to the new software version. As a result, if the certain situation that the current health check software tests for does not exist, the current health check software allows the upgrade to proceed. However, if the certain situation that the current health check software tests for does exist, the current health check software is able to block the upgrade from proceeding.

It should be appreciated the source may then repeat 406 through 410 in an ongoing manner. Along these lines, even though the source provides the current health check software at 410, the source may continue to receive additional input including feedback from the field and/or input from further lab testing, etc. To address the additional input, the source may update the current health check software at 408, and provide that current health check software at 408 in place of the earlier-provided current health check software at 410. Accordingly, at 408, the source is able to provide the most current (or most updated) health check software at the time.

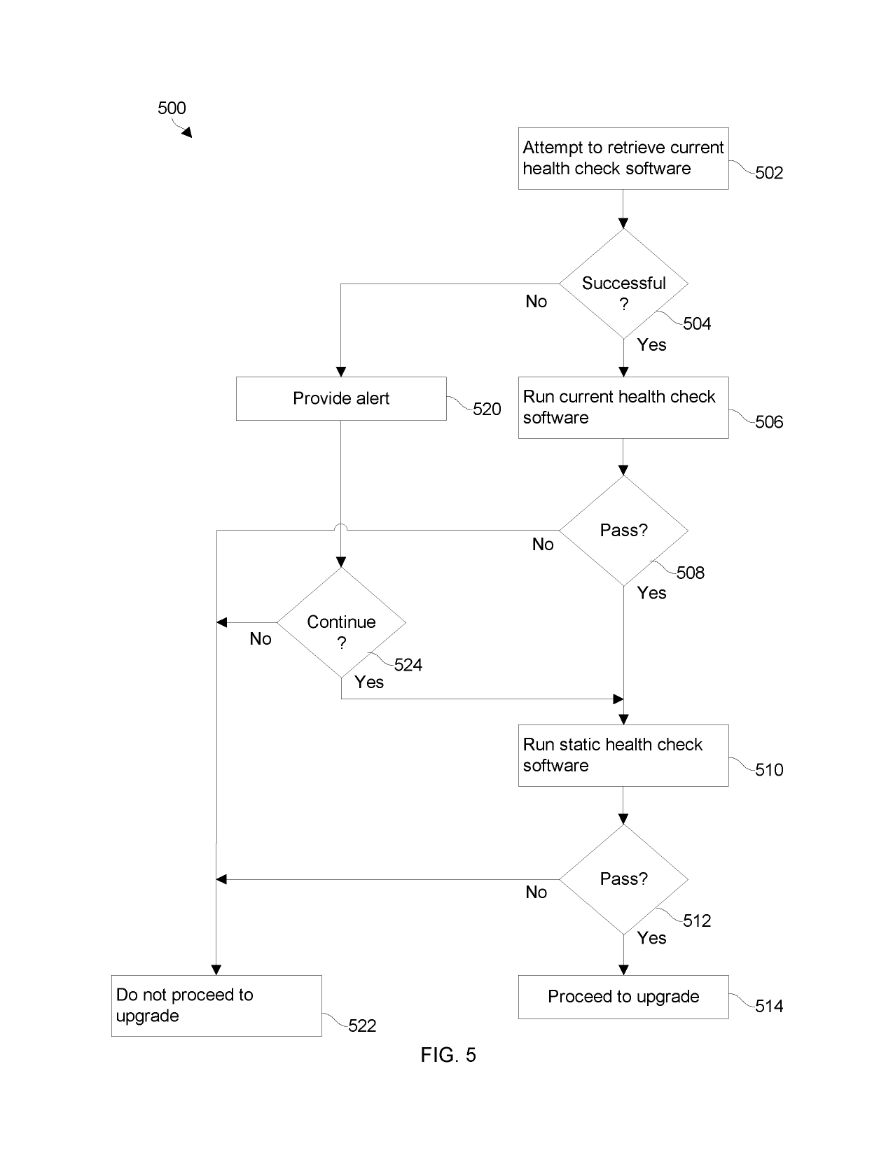

It should be further understood that if there is no current health check software to be provided (e.g., because there has been no input received to identify problems with the new software version), the source may provide, as the current health check software, an instruction that enables the upgrade routine of the upgrade package to proceed further. Along these lines, the source may provide current health check software that simply directs the upgrade routine to continue/proceed (e.g., as if running the current health check software provided a result that no problematic situation exists on the computerized platform). Further details will now be provided with reference to FIG. 5.

FIG. 5 is a flowchart of a procedure 500 which is performed by a computerized platform in accordance with certain embodiments (e.g., see the computerized equipment 100 in FIG. 1). Such a platform may be running an earlier software version and may have downloaded an upgrade package to upgrade from the earlier software version to a new software version.

To begin the procedure 500, the computerized platform accesses an upgrade routine and then operates in accordance with the upgrade routine. Along these lines, the computerized platform may have downloaded an upgrade package (e.g., see the example upgrade package 300 of FIG. 3) from a software server (e.g., see the software repository 112 of FIG. 1). The computerized platform may then run the upgrade routine of the upgrade package (e.g., in response to a user command).

After the upgrade routine starts, at 502 and in accordance with the upgrade routine, the computerized platform attempts to retrieve current health check software from an external source (e.g., the software repository 112). Along these lines, the computerized platform may establish a network connection with the external source though a computerized network and attempt to download the current health check software in a manner similar to downloading the upgrade package.

At 504, the computerized platform determines whether the attempt to download the current health check software was successful. If so, 504 proceeds to 506. If not, 504 proceeds to 520.

At 506, if the attempt to download the current health check software was successful, the computerized platform runs the current health check software. As explained earlier, the current health check software may include health checks for detecting and/or rectifying recently discovered situations (e.g., particular conditions, configurations, etc.) that have resulted in problematic upgrades. Such situations may have been discovered from earlier upgrades and/or lab tests after the upgrade package was made available. After the computerized platform runs the current health check software, 506 proceeds to 508.

At 508, if running the current health check software provides a passing result (e.g., indicating that there are no problematic situations), 508 proceeds to 510. However, if running the current health check software provides a failing result (e.g., indicating that a problematic situation exists), 508 proceeds to 522.

At 510, after the current health check software provides a passing result, the computerized platform proceeds further. In particular, the computerized platform runs static health check software of the upgrade package (if available). Such static health check software of the upgrade package may include health checks that the software provider normally includes to determine whether it is safe to perform an upgrade (e.g., by checking for known criteria indicating whether the upgrade can be performed safely). After the computerized platform runs the static health check software, 510 proceeds to 512.

At 512, if running the static health check software provides a passing result, 512 proceeds to 514. However, if running the static health check software provides a failing result, 512 proceeds to 522.

At 514, the computerized platform proceeds to upgrade the earlier software version to the new software version. Here, the computerized platform has successfully passed the health checks of the static and current health check software. Accordingly, even if problematic situations were discovered after the upgrade package was obtained by the computerized platform, the computerized platform is nevertheless able to evaluate whether it is safe to perform the upgrade using the latest information.

In some arrangements, the upgrade is a non-disruptive upgrade in which the computerized platform remains available to perform useful work during the upgrade (e.g., high availability). Here, the computerized platform may include multiple processing nodes or elements (e.g., processors, devices, appliances, etc.) such as within a cluster or federation. Accordingly, one processing node may undergo the upgrade to the new software version while one or more other processing nodes continue to operate using the earlier software version. If the upgrading processing nodes needs to pause or reboot, remaining processing nodes continue to operate.

After the processing node is upgraded, that processing node may begin operation to enable the computerized platform to continue performing useful work. At this point, remaining processing nodes may be upgraded to the new software version thus completing a non-disruptive upgrade.

Referring back to 504, it was explained that, if the computerized platform determines that the attempt to download the current health check software was unsuccessful, 504 proceeds to 520. At 520, the computerized platform provides an alert indicating that the computerized platform was unable to retrieve current health check software. Such a situation may exist if the computerized platform has lost network access (e.g., see the communications medium 114 in FIG. 1), or if there is a problem at either endpoint. 520 then proceeds to 524.

At 524, the computerized platform decides whether to continue with the upgrade routine. Along these lines, the computerized platform may receive a command directing the computerized platform to nevertheless proceed further or to terminate the upgrade routine. If the command indicates that the computerized platform should proceed with the upgrade routine, 524 proceeds to 510 to run the static health check software. However, if the command indicates that the computerized platform should not proceed with the upgrade routine, 524 proceeds to 522.

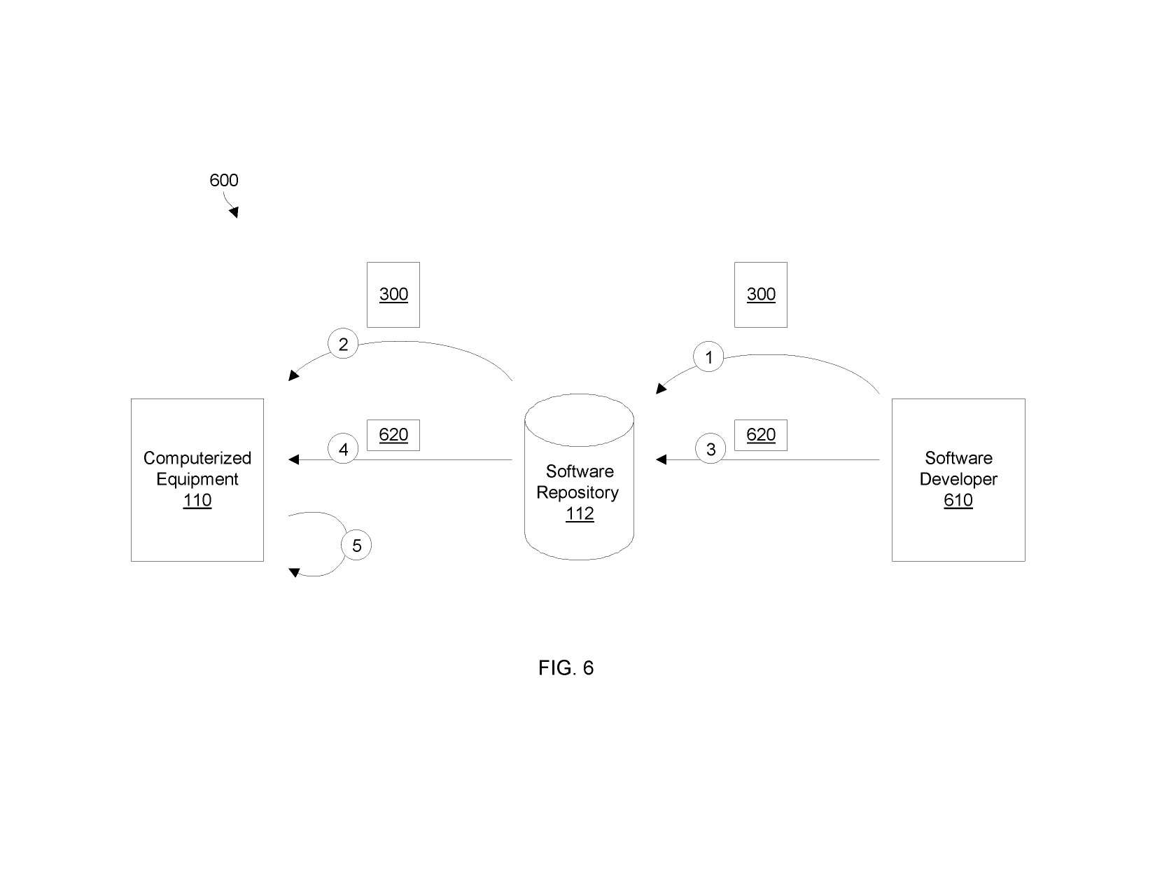

At 522, the computerized platform does not proceed to upgrade to the new software version. Here, the computerized platform safely terminates the upgrade routine without performing an upgrade, and avoids creating a potential problematic situation. Further details will now be provided with reference to FIG. 6.

FIG. 6 shows an example software upgrade situation 600 in accordance with certain embodiments. The example software upgrade situation 600 involves a software developer 610, a software repository 112, and the computerized equipment 110 (also see FIG. 1).

First, the software developer 610 creates and tests a new software version. Such a new software version may be constructed and arranged to replace an earlier software version that is currently in use among computerized platforms such as the computerized equipment 110.

When the software developer 610 is ready to allow computerized platforms to have access to the new software version, the software developer 610 includes the new software version and an upgrade routine within an upgrade package 300 and places the upgrade package 300 at the software repository 112 (arrow #1).

Recall that FIG. 3 shows a suitable arrangement for the upgrade package 300. As explained earlier, the upgrade package 300 includes a variety of constructs including an upgrade routine 310, static health check software 320, software version components 330, and perhaps other components 340.

Once the upgrade package 300 is available from the software repository 112, computerized platforms are able to download the upgrade package 300 in order to upgrade to the new software version. Along these lines, the computerized equipment 110 downloads the upgrade package 300 (arrow #2).

At this point, the computerized equipment 110 is capable of upgrading to the new software version. Here, it is possible that the computerized equipment 110 may run certain software from the upgrade package that preliminarily evaluates the computerized equipment 110 for the upgrade. At some point, suppose that the computerized equipment 110 is considered ready for the upgrade and the upgrade is scheduled to be performed at a next maintenance window (e.g., over an upcoming weekend).

Now, suppose that while the computerized equipment 110 awaits the occurrence of the next maintenance window, the software developer 610 determines that the upgrade to the new software version should not be performed in certain situations. Along these lines, the software developer 610 may receive input from other computerized platforms that have upgraded to the new software version and/or discovered the issue via testing in the lab. For example, perhaps a small percentage of the computerized platforms have a particular situation that encounters problems when using the new software version. Accordingly, the software developer 610 creates current health check software 620 constructed and arranged to check for (and perhaps even rectify) the particular situation and places the current health check software 620 on the software repository 112 (arrow #3) for access by computerized platforms (also see the procedure 400 in FIG. 4). As a result, there is now current health check software available from the software repository 112 even after the upgrade package 300 was made available.

In some situations, if there are no issues with the upgrade package 300, the software developer 610 may put a minimal placeholder instruction (or command) on the software repository 112 as the current health check software 620. Such a minimal placeholder instruction is constructed and arranged to enable computerized platforms to successfully retrieve the current health check software 620 and proceed even though there are no issues with the upgrade package 300.

Additionally, in some situations, after the current health check software 620 is placed on software repository 112, the software developer 610 may receive further input regarding additional problematic situations. In these situations, the software developer 110 may create additional (or newer) current health check software 620 constructed and arranged to check for the particular configuration as well as the additional problematic situations and then place that current health check software 620 on the software repository 112 for access by computerized platforms. Accordingly, the current health check software 620 on the software repository 112 may be the latest health check software available to computerized platforms.

At this point, suppose that the maintenance window has arrived for the computerized equipment 110. Accordingly, the computerized equipment 110 runs the upgrade routine to upgrade to the new software version (also see the procedure 500 in FIG. 5). Along these lines, the before proceeding to the actual upgrade, the computerized equipment 110 attempts to retrieve the current health check software 620 from the software repository 112 (see 502 in FIG. 5). If the attempt to retrieve the current health check software 620 is successful (arrow #4), the computerized equipment 110 is then able run the current health check software 620 to determine whether it is safe to upgrade from the earlier software version to the new software version (see 506 in FIG. 5).

If the computerized equipment 110 ascertains that it is safe to upgrade from the earlier software version to the new software version, the computerized equipment 110 proceeds to upgrade to the new software version using the upgrade package 300 (arrow #5). Along these lines, the computerized equipment 110 may receive a passing result in response to running the current health check software 620 (or detect the minimal placeholder instruction indicating that the computerized equipment 110 may proceed).

In some arrangements, the current health check software 620 not only checks for problematic situation, but also is equipped to correct/adjust situations prior to performing upgrades to avoid problematic upgrade results. Accordingly, the computerized equipment 110 is able to benefit from the availability of the current health check software 620 even though the current health check software 620 was provided on the software repository 112 after the computerized equipment 110 had retrieved the upgrade package 300 and after the computerized equipment 110 had scheduled the upgrade.

As described above, improved techniques are directed to utilizing an upgrade package 300 which defines an upgrade routine 310 constructed and arranged to automatically attempt to retrieve and run current health check software 620 from a software repository 112 before upgrading an earlier software version to a new software version within computerized equipment 110. The current health check software 620 (which may have been made available after the upgrade package 300 was released in order to check for recently discovered problematic system conditions, configurations, etc.) may then block/prevent the upgrade to the new software version (or even make adjustments to enable the upgrade to safely proceed) thereby avoiding the problematic situations.

One should appreciate that the above-described techniques do not merely move and/or modify data. Rather, the disclosed techniques involve improvements to the technology of upgrading software. With such techniques, various advantages are available such as safeguarding computerized platforms from performing upgrades that would create problematic situations, enable computerized platforms to correct/adjust configurations prior to performing upgrades to avoid the problematic situations, combinations thereof, and so on.

While various embodiments of the present disclosure have been particularly shown and described, it will be understood by those skilled in the art that various changes in form and details may be made therein without departing from the spirit and scope of the present disclosure as defined by the appended claims.

For example, it should be understood that various components of the computerized environment 100 such as the software repository 112, the host computers 116, the software developer 610, etc. are capable of being implemented in or “moved to” the cloud, i.e., to remote computer resources distributed over a network. Here, the various computer resources may be distributed tightly (e.g., a server farm in a single facility) or over relatively large distances (e.g., over a campus, in different cities, coast to coast, etc.). In these situations, the network connecting the resources is capable of having a variety of different topologies including backbone, hub-and-spoke, loop, irregular, combinations thereof, and so on. Additionally, the network may include copper-based data communications devices and cabling, fiber optic devices and cabling, wireless devices, combinations thereof, etc. Furthermore, the network is capable of supporting LAN-based communications, SAN-based communications, combinations thereof, and so on.

Some embodiments are directed to a method to upgrade software within computerized equipment. The method includes receiving an upgrade package defining an upgrade routine constructed and arranged to automatically attempt to retrieve and run current health check software from a software repository before upgrading an earlier software version to a new software version within the computerized equipment, the software repository being external to the computerized equipment. The method further includes receiving an upgrade command to perform the upgrade routine defined by the upgrade package. The method further includes, in response to the upgrade command and in accordance with the upgrade routine, automatically attempting to retrieve and run the current health check software from the software repository before upgrading the earlier software version to the new software version within the computerized equipment.

Other embodiments are directed to computerized equipment which includes memory, and control circuitry coupled to the memory. The memory storing instructions which, when carried out by the control circuitry, cause the control circuitry to perform a method of:

(A) receiving an upgrade package defining an upgrade routine constructed and arranged to automatically attempt to retrieve and run current health check software from a software repository before upgrading an earlier software version to a new software version within the computerized equipment, the software repository being external to the computerized equipment,

(B) receiving an upgrade command to perform the upgrade routine defined by the upgrade package, and

(C) in response to the upgrade command and in accordance with the upgrade routine, automatically attempting to retrieve and run the current health check software from the software repository before upgrading the earlier software version to the new software version within the computerized equipment.

Yet other embodiments are directed to a computer program product having a non-transitory computer readable medium which stores a set of instructions to upgrade software within computerized equipment. The set of instructions, when carried out by computerized circuitry, causing the computerized circuitry to perform a method of:

(A) receiving an upgrade package defining an upgrade routine constructed and arranged to automatically attempt to retrieve and run current health check software from a software repository before upgrading an earlier software version to a new software version within the computerized equipment, the software repository being external to the computerized equipment;

(B) receiving an upgrade command to perform the upgrade routine defined by the upgrade package; and

(C) in response to the upgrade command and in accordance with the upgrade routine, automatically attempting to retrieve and run the current health check software from the software repository before upgrading the earlier software version to the new software version within the computerized equipment.

In some arrangements, automatically attempting to retrieve and run the current health check software from the software repository includes successfully retrieving the current health check software from the software repository.

In some arrangements, the current health check software is constructed and arranged to evaluate whether upgrading the earlier software version to the new software version within the computerized equipment is performable non-disruptively based on a current set of criteria. Additionally, automatically attempting to retrieve and run the current health check software from the software repository includes upon successful retrieval of the current health check software from the software repository, running the current health check software within the computerized equipment.

In some arrangements, receiving the upgrade package includes receiving, as part of the upgrade package, static health check software which is constructed and arranged to evaluate whether upgrading the earlier software version to the new software version within the computerized equipment is performable non-disruptively based on a static set of criteria, the static set of criteria potentially being different from the current set of criteria.

In some arrangements, running the current health check software within the computerized equipment provides a passing current health check result. Additionally, the method further includes, in response to the passing current health check result, automatically running the static health check software within the computerized equipment.

In some arrangements, automatically running the static health check software within the computerized equipment provides a passing static health check result. Additionally, the method further includes, in response to the passing static health check result, automatically upgrading the earlier software version to the new software version within the computerized equipment.

In some arrangements, the upgrade package further includes new software version components for a non-disruptive upgrade of the earlier software version to the new software version. Additionally, automatically upgrading the earlier software version to the new software version within the computerized equipment includes performing a non-disruptive upgrade of the earlier software version to the new software version within the computerized equipment using the new software version components of the upgrade package.

In some arrangements, the computerized equipment is data storage equipment constructed and arranged to process input/output (I/O) requests on behalf of a set of host computers. Additionally, the method further includes processing I/O requests on behalf of the set of host computers while the non-disruptive upgrade of the earlier software version to the new software version is being performed.

In some arrangements, automatically running the static health check software within the computerized equipment provides a failing static health check result. Additionally, the method further includes, in response to the failing static health check result, automatically terminating upgrading of the earlier software version to the new software version within the computerized equipment.

In some arrangements, running the current health check software within the computerized equipment provides a failing current health check result. Additionally, the method further includes, in response to the failing current health check result, automatically terminating upgrading of the earlier software version to the new software version within the computerized equipment.

In some arrangements, the current health check software is constructed and arranged to evaluate whether upgrading the earlier software version to the new software version within the computerized equipment is performable non-disruptively based on a current set of criteria. Additionally, automatically attempting to retrieve and run the current health check software from the software repository includes failing to retrieve the current health check software from the software repository.

In some arrangements, the method further includes providing an alert indicating that retrieval of the current health check software from the software repository was unsuccessful, and providing a query for input as to whether upgrading is to continue.

In some arrangements, receiving the upgrade package includes receiving, as part of the upgrade package, static health check software which is constructed and arranged to evaluate whether upgrading the earlier software version to the new software version within the computerized equipment is performable non-disruptively based on a static set of criteria, the static set of criteria potentially being different from the current set of criteria. Additionally, the method further includes:

(i) after the query is provided, receiving a continue command to continue performing the upgrade routine, and

(ii) running the static health check software within the computerized equipment in response to the continue command.

In some arrangements, running the static health check software within the computerized equipment provides a passing static health check result. Additionally, the method further includes, in response to the passing static health check result, automatically upgrading the earlier software version to the new software version within the computerized equipment.

In some arrangements, running the static health check software within the computerized equipment provides a failing static health check result. Additionally, the method further includes, in response to the failing static health check result, automatically terminating upgrading of the earlier software version to the new software version within the computerized equipment.

It should be understood that, in the cloud context, at least some of electronic circuitry is formed by remote computer resources distributed over a network. Such an electronic environment is capable of providing certain advantages such as high availability and data protection, transparent operation and enhanced security, big data analysis, etc.

Other embodiments are directed to electronic systems and apparatus, processing circuits, computer program products, and so on. Some embodiments are directed to various methods, electronic components and circuitry which are involved in automatically attempting to retrieve and run current health check software before upgrading to a new software version.

It should be appreciated that PUHC scripts may already exist, but only within the overall software package containing a specific software version. These PUHC scripts are static with respect to the software version. Once released, the PUHC logic remains unchangeable and cannot incorporate any new checks or workarounds that are identified after the software version is released.

Additionally, software updates may already exist – both in embedded systems as well as other technologies. However, these conventional software updates are not gated on dynamic checks that can be updated out-of-band with respect to the released software. Accordingly, unlike the improved techniques disclosed herein, the conventional software updates do not enjoy certain benefits – for example, allowing an upgrade to either block or potentially even correct an underlying error condition based on information obtained only after the release has been completed and made available to the field.

Other conventional technologies, such as antivirus, have a similar functionality in that such technologies allow virus definitions to be updated after the antivirus engine has been released. These conventional technologies are simply data-only updates (for virus definitions) which do not include the ability to basically inject new code into the existing release to allow much more dynamic operation as in the improved techniques disclosed herein.

For example, one or more embodiments involve blocking an upgrade based on an algorithm to detect a potentially problematic state of the existing application that is only present in the upgraded version. Another example uses the upgrade code to not only detect, but also correct the potential problematic state and automatically allow the upgrade to continue with the new-corrected state.

In accordance with one or more embodiments, a mechanism updates embedded systems (storage systems in particular) dynamically based on contextual analysis performed by the update engine. Such a mechanism may not only perform an update but choose to do so (or choose not to do so) based on dynamic analysis of the current state of the embedded system. An analysis engine is an independent component capable itself of being updated outside of the normal “upgrade” process. This provides the capability to alter the software operation based on algorithms that can be updated completely outside of the normal upgrade process and which can be “smarter” than simple true/false checks.

For example, such techniques may involve health checks associated with Non-Disruptive Upgrades (NDU). NDU capability is an essential feature for storage systems, allowing a customer to upgrade to a more recent version of software without disrupting their application environment.

In accordance with certain embodiments, in order to ensure that the NDU process is truly non-disruptive, there are a set of Pre-Upgrade Health Checks (PUHC) that are currently executed to check the status of various components on the system to be upgraded to validate that it is both ready and safe to start the upgrade process on. This may be necessary because the upgrade process may need to take down one node of a dual node system for the upgrade, making the overall storage appliance “degraded” for part of the upgrade. The PUHCs are generally in place to validate that the NDU operation has a high probability of success and does not leave the system in a failed state. Do note that PUHCs currently check a single point in time prior to starting the NDU operation and there are certainly failures that can occur during the NDU that will cause the upgrade operation to fail, but the PUHCs are best effort and attempt to detect those anomalies that are present prior to the upgrade that could potentially cause issues with the upgrade process as a whole.

Customers currently have the flexibility to download the NDU “package” and perform the upgrade at their convenience and without requiring software developer support to aid in the procedure. This flexibility is great for the customer, but it does provide some challenges for the software developer. In particular, if the software developer discovers an issue with a specific version (e.g., referred to as version B), there are currently two primary approaches to prevent a potentially problematic upgrade. The first is to remove version B from the public website. This has several problems – first, there is reputation damage when a released version is removed from public availability. Second, removal of that version from the website cannot remove the affected version from customers that have already downloaded that version – even if they have not yet installed that version. The second option is to reach out to customers directly and request them to not use the version with issues, but this requires direct communication to customers that is not always possible.

Both of these options suffer from being potentially too general, as well. In cases where version B only has issues if the installed version (e.g, referred to as version A) already has some issues that can be detected and otherwise will be fine, an issue-specific check to block the problematic upgrade would be advantageous as this would allow for blocking upgrades on only appliances that might actually hit the problem (which might be in the minority of systems in the field as a whole) while still allowing those appliances that do not have the required preconditions to hit the known problem to continue with their upgrades (assuming all other checks pass, of course).

The PUHCs referred to earlier do not generally provide the capability to block these types of upgrade because they are directly released with the software package. In many cases, an issue is not detected until version B is released to the field and some systems hit the issue and the root cause is identified. By then, it is too late to directly update the PUHCs that have already been delivered with version B.

Note that this type of case is somewhat common, especially as appliances age in the field. The number of factors (and upgrade paths) impacting NDU increases exponentially and the tests associated with NDU take a long time, so it is simply not possible to economically verify all possible hardware combinations and software upgrade paths from the very first software release to the current software release.

In accordance with one or more embodiments, the upgrade process, at the time of upgrade (“just in time”), can reach out for updated PUHC software modules from a well-defined location. This location would only supply signed updates to guarantee the PUHCs have been vetted, validated and published by the software developer. These PUHCs will be the most up-to-date available at the time of the attempted upgrade and importantly, these PUHCs will have the ability to use information learned from the results of other customer upgrades (especially upgrade failures with root cause known) and even failed internal tests that were too late to inform the PUHCs included in version B’s PUHCs. Each PUHCs business logic will be up-to-date and can utilize any information available on the customer’s system to determine if the upgrade may face potential problems, avoiding unnecessary upgrade failures and possibility of data unavailability or even data loss.

Essential Points in accordance with one or more embodiments:

The ability to download upgrading software modules associated with a specific software release (one or more) at a specific orchestration point (such as prior to an upgrade)

The ability for this downloaded software module to dynamically update the operation of an existing software module – for example, to examine the state of a system to determine if a potentially problematic state exists on the system. If so, the downloaded software module can simply fail the upgrade with an appropriate message and avoid a potential data unavailable or data loss situation, or the downloaded module could even automatically attempt to fix the problematic state and allow the upgrade to continue

The downloaded software module can make use of any information available on the system to execute its stored algorithm(s) – for example, the platform type, currently-installed version (version A), h/w state (e.g. drive count, offline drives), total physical capacity, specific data layout, etc. (nothing in this invention limits what potential available information on the appliance could be utilized in the algorithm execution)

### Solution in accordance with one or more embodiments:

1. Client software that runs on the storage system (embedded system). At specific orchestration points during the upgrade process, the client software will query the server (item 2) for updated software modules to be downloaded and executed as part of the pre-upgrade process.

2. Server software that hosts updated software modules to be downloaded and executed at specific orchestration points in the upgrade process.

3. The client software will provide a warning if unable to contact the server (item 2) or otherwise download updated software modules, but will allow the user to continue if they desire with an appropriate message indicating the checks may not be fully up-to-date.

4. The client software will download the latest software modules and execute those at the appropriate orchestration points for the upgrade process.

5. Depending on the output from the downloaded software modules, the overall upgrade process will continue or fail.

6. Updated software modules are signed to ensure they have been properly validated and are genuine modules from the software developer.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

Along these lines, the computerized equipment 110 was described above as being data storage equipment by way of example only. Other types of computerized platforms which involve upgrading an earlier software version to a new software version are suitable for use as well. Such modifications and enhancements are intended to belong to various embodiments of the disclosure.

What is claimed is:

1. A method to upgrade software within computerized equipment, the method comprising:
receiving an upgrade package defining an upgrade routine constructed and arranged to automatically attempt to retrieve and run current health check software from a software repository before upgrading an earlier software version to a new software version within the computerized equipment, the software repository being external to the computerized equipment;
receiving an upgrade command to perform the upgrade routine defined by the upgrade package; and
in response to the upgrade command and in accordance with the upgrade routine, automatically attempting to retrieve and run the current health check software from the software repository before upgrading the earlier software version to the new software version within the computerized equipment.

2. The method of claim 1, wherein automatically attempting to retrieve and run the current health check software from the software repository includes:
successfully retrieving the current health check software from the software repository.

3. The method of claim 2, wherein the current health check software is constructed and arranged to evaluate whether upgrading the earlier software version to the new software version within the computerized equipment is performable non-disruptively based on a current set of criteria; and
wherein automatically attempting to retrieve and run the current health check software from the software repository includes:
upon successful retrieval of the current health check software from the software repository, running the current health check software within the computerized equipment.

4. The method of claim 3, wherein receiving the upgrade package includes:
receiving, as part of the upgrade package, static health check software which is constructed and arranged to evaluate whether upgrading the earlier software version to the new software version within the computerized equipment is performable non-disruptively based on a static set of criteria, the static set of criteria being different from the current set of criteria.

5. The method of claim 4 wherein running the current health check software within the computerized equipment provides a passing current health check result; and
wherein the method further comprises:
in response to the passing current health check result, automatically running the static health check software within the computerized equipment.

6. The method of claim 5 wherein automatically running the static health check software within the computerized equipment provides a passing static health check result; and
wherein the method further comprises:
in response to the passing static health check result, automatically upgrading the earlier software version to the new software version within the computerized equipment.

7. The method of claim 6 wherein the upgrade package further includes new software version components for a non-disruptive upgrade of the earlier software version to the new software version; and
wherein automatically upgrading the earlier software version to the new software version within the computerized equipment includes:
performing a non-disruptive upgrade of the earlier software version to the new software version within the computerized equipment using the new software version components of the upgrade package.

8. The method of claim 7 wherein the computerized equipment is data storage equipment constructed and arranged to process input/output (I/O) requests on behalf of a set of host computers; and
wherein the method further comprises:
processing I/O requests on behalf of the set of host computers while the non-disruptive upgrade of the earlier software version to the new software version is being performed.

9. The method of claim 5 wherein automatically running the static health check software within the computerized equipment provides a failing static health check result; and
wherein the method further comprises:
in response to the failing static health check result, automatically terminating upgrading of the earlier software version to the new software version within the computerized equipment.

10. The method of claim 4 wherein running the current health check software within the computerized equipment provides a failing current health check result; and
wherein the method further comprises:
in response to the failing current health check result, automatically terminating upgrading of the earlier software version to the new software version within the computerized equipment.

11. The method of claim 1, wherein the current health check software is constructed and arranged to evaluate whether upgrading the earlier software version to the new software version within the computerized equipment is performable non-disruptively based on a current set of criteria; and
wherein automatically attempting to retrieve and run the current health check software from the software repository includes:
failing to retrieve the current health check software from the software repository.

12. The method of claim 11, wherein the method further comprises:
providing an alert indicating that retrieval of the current health check software from the software repository was unsuccessful, and
providing a query for input as to whether upgrading is to continue.

13. The method of claim 12, wherein receiving the upgrade package includes:
receiving, as part of the upgrade package, static health check software which is constructed and arranged to evaluate whether upgrading the earlier software version to the new software version within the computerized equipment is performable non-disruptively based on a static set of criteria, the static set of criteria being different from the current set of criteria; and
wherein the method further comprises:
after the query is provided, receiving a continue command to continue performing the upgrade routine, and
running the static health check software within the computerized equipment in response to the continue command.

14. The method of claim 13 wherein running the static health check software within the computerized equipment provides a passing static health check result; and
wherein the method further comprises:
in response to the passing static health check result, automatically upgrading the earlier software version to the new software version within the computerized equipment.

15. The method of claim 14 wherein running the static health check software within the computerized equipment provides a failing static health check result; and
wherein the method further comprises:
in response to the failing static health check result, automatically terminating upgrading of the earlier software version to the new software version within the computerized equipment.

16. Computerized equipment, comprising:
memory; and
control circuitry coupled to the memory, the memory storing instructions which, when carried out by the control circuitry, cause the control circuitry to:
receive an upgrade package defining an upgrade routine constructed and arranged to automatically attempt to retrieve and run current health check software from a software repository before upgrading an earlier software version to a new software version within the computerized equipment, the software repository being external to the computerized equipment,
receive an upgrade command to perform the upgrade routine defined by the upgrade package, and
in response to the upgrade command and in accordance with the upgrade routine, automatically attempt to retrieve and run the current health check software from the software repository before upgrading the earlier software version to the new software version within the computerized equipment.

17. The computerized equipment of claim 16, wherein automatically attempting to retrieve and run the current health check software from the software repository includes:
successfully retrieving the current health check software from the software repository, the current health check software being constructed and arranged to evaluate whether upgrading the earlier software version to the new software version within the computerized equipment is performable non-disruptively based on a current set of criteria,
upon successful retrieval of the current health check software from the software repository, running the current health check software within the computerized equipment, and
after running the current health check software within the computerized equipment, automatically upgrading the earlier software version to the new software version within the computerized equipment.

18. The computerized equipment of claim 17 wherein the computerized equipment is data storage equipment constructed and arranged to process input/output (I/O) requests on behalf of a set of host computers; and
wherein the method further comprises:
processing I/O requests on behalf of the set of host computers while automatically upgrading the earlier software version to the new software version.

19. A computer program product having a non-transitory computer readable medium which stores a set of instructions to upgrade software within computerized equipment; the set of instructions, when carried out by computerized circuitry, causing the computerized circuitry to perform a method of:
receiving an upgrade package defining an upgrade routine constructed and arranged to automatically attempt to retrieve and run current health check software from a software repository before upgrading an earlier software version to a new software version within the computerized equipment, the software repository being external to the computerized equipment;
receiving an upgrade command to perform the upgrade routine defined by the upgrade package; and
in response to the upgrade command and in accordance with the upgrade routine, automatically attempting to retrieve and run the current health check software from the software repository before upgrading the earlier software version to the new software version within the computerized equipment.
